(19) United States
(12) Patent Application Publication
(10) Pub. No.: US 2012/0056346 A1
(43) Pub. Date: Mar. 8, 2012

(54) IMPROVED METHOD FOR EXTRACTING SHAPED FOAM ARTICLES FROM A FORMING MOLD CAVITY

(76) Inventors: Myron J. Maurer, Saginaw, MI (US); Matthew D. Mittag, Midland, MI (US); Saman R. Teli, Midland, MI (US); Casey R. Fiting, Freeland, MI (US)

(21) Appl. No.: 13/318,491

(22) PCT Filed: May 5, 2010
(86) PCT No.: PCT/US2010/033645

§ 371 Date: Nov. 2, 2011

Related U.S. Application Data
(60) Provisional application No. 61/180,464, filed on May 22, 2009.

(51) Int. Cl. B29C 43/00

(52) U.S. Cl. 264/48

(57) ABSTRACT

The invention relates to an improved method of extracting a shaped foam article from a mold cavity after being formed, specifically by imparting a vacuum sufficient enough to hold the shaped foam article to one side of the mold, preferably the core half of the mold, when the mold opens.

### FIELD OF THE INVENTION

The invention relates to an improved method of extracting a shaped foam article from a mold cavity after being formed, specifically by imparting vacuum sufficient enough to hold the shaped foam article on one side of the mold, preferably the core half of the mold, when the mold opens.

### BACKGROUND OF THE INVENTION

Various methods and techniques are currently known and employed in the industry for shaping articles from a thermoplastic foam material, such as extruded polystyrene (XPS) foams. For example, shapes such as toys and puzzles can be die cut from foams that are formed by extruding a thermoplastic resin containing a blowing agent. There are also examples of foam sheet being shaped into articles such as dishes, cups, egg cartons, trays, and various types of food containers, such as fast food clam shells, take out/take home containers, and the like. More complex shaped foam articles can be made by thermoforming thermoplastic foam sheet. These methods lend themselves to the manufacture of relatively simple shaped articles from typically thin foams which are easily extracted from the molds used to produce them.

Recently, there have been significant advances in shaping more complex, and in particular, thicker thermoplastic foam (i.e., foams greater than 1 mm thick), shaped articles by pressing unique foam compositions and/or structures, for example see USP Publication 2009-0062410. Because of the complex shapes and/or thickness of such shaped foam articles, sometimes when the mold opens, a high degree of frictional forces retain the shaped foam article in the mold cavity responsible for forming the article. However, traditional methods to extract the shaped foam articles from mold cavities, such as ejector pins, shear plates, air ejection, and the like may damage foam articles and result in mechanical and/or aesthetic defects in the shaped foam article. An effective remedy to this problem from the standpoint of reducing defects is to hand remove each shaped foam article from the mold cavity. However, this can be impractical, if not impossible, for multi-cavity tools. Furthermore, hand removal is time consuming, and thus costly, and does not lend itself to cost-effective high throughput.

It would be desirable to have a simple, cost effective extraction method integrated into a shaping mold that can easily be automated and enables the extraction of dimensionally and aesthetically acceptable shaped foam articles.

### SUMMARY OF THE INVENTION

The present invention is such a simple, cost-effective method to extract dimensionally and aesthetically acceptable shaped foam articles from the cavity of a shaping mold, increase throughput of fabricated shaped foam articles, and reduce scrap rates.

In one embodiment, the present invention is a method to manufacture one or more shaped foam article using a press with a movable platen and a stationary platen having a mold with at least a cavity half affixed to either the movable platen or the stationary platen wherein the platen that does not have the cavity half of the mold affixed to it has means to apply a negative pressure through it comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank,
wherein the foam plank has
   (i)(a) a vertical compressive balance equal to or greater than 0.4 and
   (i)(b) one or more pressing surface;
(ii) applying a negative pressure though the platen without the cavity half of the mold to the bottom surface of the foam plank,
(iii) shaping the one or more pressing surface of the foam plank into one or more shaped foam article and surrounding continuous unshaped foam plank by
   (iii)(a) moving the movable platen in contact with the foam plank,
   (iii)(b) pressing the foam plank into the cavity half of the mold, said cavity half of the mold comprises one or a plurality of cavities each cavity having a perimeter defining the shape of the shaped foam article, and
   (iii)(c) forming one or more shaped foam article,
   (iii)(d) retracting the movable platen from the stationary platen,
whereby the one or more shaped foam article is retained by negative pressure on the platen without the cavity half of the mold.

In another embodiment of the present invention, the method to manufacture one or more shaped foam article uses a mold half with a cavity affixed to the movable platen and is referred to as the movable forming surface and the stationary platen is referred to as the stationary forming surface. In this embodiment the stationary forming surface has means to apply a negative pressure through. The method to manufacture one or more shaped foam article comprises the steps of:
(i) extruding a thermoplastic polymer, preferably polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend, with a blowing agent, preferably a chemical blowing agent, an inorganic gas, an organic blowing agent, carbon dioxide, or combinations thereof, to form a thermoplastic polymer foam plank, the plank having a thickness, a top surface, and a bottom surface in which said surfaces lie in the plane defined by the direction of extrusion and the width of the plank, preferably the foam has an internal cell gas pressure equal to or less than 1 atmosphere
wherein the foam plank has
   (i)(a) a vertical compressive balance equal to or greater than 0.4 and
   (i)(b) one or more pressing surface;
(ii) applying a negative pressure though the stationary forming surface to the bottom surface of the foam plank,
(iii) shaping the one or more pressing surface of the foam plank into one or more shaped foam article and surrounding continuous unshaped foam plank by
   (iii)(a) moving the movable forming surface of the mold in contact with the foam plank, said surface comprising one or a plurality of cavities each cavity having a perimeter defining the shape of the shaped foam article,
   (iii)(b) pressing the foam plank with the movable forming surface whereby forming one or more shaped foam article, and
   (iii)(c) retracting the movable forming surface from the one or more shaped foam article
whereby the one or more shaped foam article is retained by negative pressure on the stationary forming surface of the mold.

In one embodiment of the present invention, the means to apply negative pressure through the platen without the cavity half of the mold, preferably the stationary forming surface, comprise one or more hole through which vacuum may be applied, preferably the means to apply negative pressure further comprises a seal means between the foam plank and platen without the cavity half of the mold, preferably the stationary forming surface.

In a preferred embodiment, the seal means comprises a groove in the platen without the cavity half of the mold, preferably the stationary forming surface, and a seal that fits within the groove wherein the perimeter of the groove is smaller than the shape of the shaped foam article as defined by the perimeter of the mold cavity.

In another embodiment of the present invention, the platen without the cavity half of the mold, preferably stationary forming surface, comprises a porous media through which the negative pressure is applied.

In another embodiment of the present invention, the pressing surface is created by the step of
(i)(b)(1) removing a layer of foam at least 1 millimeter thick from the top surface, the bottom surface, or both the top and bottom surfaces
or
(i)(b)(2) cutting the foam plank between the top and the bottom surfaces creating two pressing surfaces opposite the top and bottom surfaces.

A further embodiment of the present invention is a shaped foam article made by the method described hereinabove, preferably the shaped foam article is a foam trim, an automotive part, a decorative insulation, safety equipment, packaging material, form-fit insulation, an insulated sheathing, an insulated building cladding, a decorative trim, a vinyl siding backing, an integrated radiant floor heating panel, a sandwich panel with non-planer faces, a composite panel, foot wear, a buoyancy part for boats or watercraft, a decoration product for a craft application, an energy absorption component in a helmet, an energy absorption component in a military application, an energy absorption component in an automotive article, a foam composite part for windmill turbine blades, composite roof tiles, or a cushion packaging article.

### BRIEF DESCRIPTION OF THE DRAWINGS

FIG. 1 is an illustration of the step change in the shaped foam article of this invention.

FIG. 2 is a top view of a stationary platen with vacuum seal and vacuum holes.

FIG. 3 is a cross-sectional view of a stationary platen with vacuum seal and vacuum holes.

FIG. 4 is a cross-sectional view of a forming tool with foam plank with vacuum seal in the open position prior to shaping.

FIG. 5 is a cross-sectional view of a forming tool with trimmed and shaped foamed plank with vacuum seal in the closed position.

FIG. 6 is a cross-sectional view of a forming tool with shaped foam article with vacuum seal in the open position after shaping.

### DETAILED DESCRIPTION OF THE INVENTION

The present invention is a method of extracting complex shaped foam articles from the cavity of a forming tool. The foamed article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 20 percent or less, more preferably 10 percent or less and still more preferably 5 percent or less and most preferably one percent or less open cell content. Conversely, an open cell foam has 30 percent or more, preferably 50 percent or more, still more preferably 70 percent or more, yet more preferably 90 percent or more open cell content. An open cell foam can have 95 percent or more open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article of the present invention.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of their good balance between cost and property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides for a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer.

Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared by any conceivable method. Suitable methods for preparing polymeric foam articles include batch processes (such as expanded bead foam steam chest molding processes), semi-batch processes (such as accumulative extrusion processes) and continuous processes such as extrusion foam processes. Desirably, the process is a semi-batch or continuous extrusion process. Most preferably process comprises an extrusion process.

An expanded bead foam process is a batch process that requires preparing a foamable polymer composition by incorporating a blowing agent into granules of polymer composition (for example, imbibing granules of a thermoplastic polymer composition with a blowing agent under pressure). Each bead becomes a foamable polymer composition. Often, though not necessarily, the foamable beads undergo at least two expansion steps. An initial expansion occurs by heating the granules above their softening temperature and allowing the blowing agent to expand the beads. A second expansion is often done with multiple beads in a mold and then exposing the beads to steam to further expand them and fuse them together. A bonding agent is commonly coated on the beads before the second expansion to facilitate bonding of the beads together. The resulting expanded bead foam has a characteristic continuous network of polymer skins throughout the foam. The polymer skin network corresponds to the surface of each individual bead and encompasses groups of cells throughout the foam. The network is of higher density than the portion of foam containing groups of cells that the network encompasses.

Complex articles or blocks may be produced by steam chest molding. Blocks may be further shaped by cutting, for example by CNC hot wire, to a sheet of uniform thickness. A structural insulated panel (SIP) is an example of a steam chest molded block foam cut into uniform thickness sheet.

The foamed article can also be made in a reactive foaming process, in which precursor materials react in the presence of a blowing agent to form a cellular polymer. Polymers of this type are most commonly polyurethane and polyepoxides, especially structural polyurethane foams as described, for example, in U.S. Pat. Nos. 5,234,965 and 6,423,755, both hereby incorporated by reference. Typically, anisotropic characteristics are imparted to such foams by constraining the expanding reaction mixture in at least one direction while allowing it to expand freely or nearly freely in at least one orthogonal direction.

An extrusion process prepares a foamable polymer composition of a thermoplastic polymer with a blowing agent in an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming. An extruded foam can be a continuous, seamless structure, such as a sheet or profile, as opposed to a bead foam structure or other composition comprising multiple individual foams that are assembled together in order to maximize structural integrity and thermal insulating capability. An extruded foam sheet may have post-extrusion modifications performed to it as desired, for example edge treatments (e.g., tongue and groove), thickness tolerance control (e.g., via planning or skiving the surface), treatments to the top and/or bottom of the sheet, such as cutting grooves into the surface, and the like.

Accumulative extrusion is a semi-continuous extrusion process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, hereby incorporated by reference, discloses such a process in a context of making polyolefin foams, yet which is readily adaptable to aromatic polymer foam. U.S. Pat. No. 3,268,636 discloses the process when it takes place in an injection molding machine and the thermoplastic with blowing agent is injected into a mold and allowed to foam, this process is sometimes called structural foam molding. Accumulative extrusion and extrusion processes produce foams that are free of such a polymer skin network.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorintated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The amount of blowing agent can be determined by one of ordinary skill in the art without undue experimentation for a given thermoplastic to be foamed based on the type thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or less than about 160 kg/m³, more preferably equal to or less than about 120 kg/m³, and most preferably equal to or less than about 100 kg/m³.

The cells of the foam article may have an average size (largest dimension) of from about 0.05 to about 5.0 millimeter (mm), especially from about 0.1 to about 3.0 mm, as measured by ASTM D-3576-98. Foam articles having larger average cell sizes, of especially about 1.0 to about 3.0 mm or about 1.0 to about 2.0 mm in the largest dimension, are of particular use when the foam fails to have a compressive ratio of at least 0.4 as described in the following few paragraphs.

The compressive strength of the foam article is established when the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T}, has a value of at least 0.40, preferably a value of at least 0.45 and most preferably a value of at least 0.50. When using such a foam, the pressing direction is desirably parallel to the maximum value in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

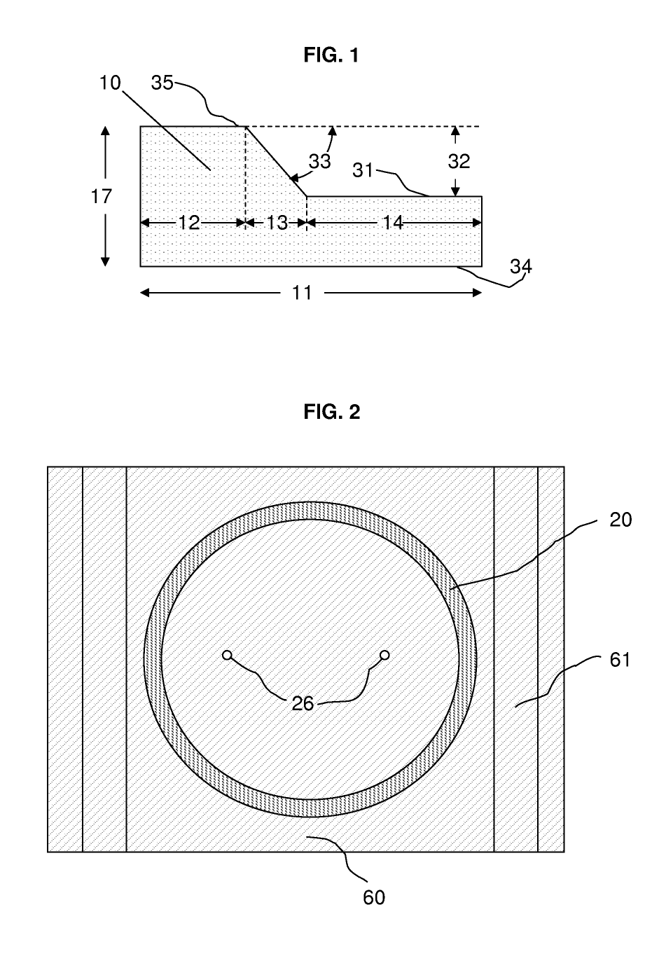

A most preferred foam article is a shaped foam article which may be prepared from a foamed polymer as described herein above in the form of a foam plank and further shaped to give a shaped foam article. The use of the term plank, herein, is merely used for convenience with the understanding that configurations other than a flat board having a rectangular cross-section may be extruded and/or foamed (e.g., an extruded sheet, an extruded profile, a pour-in-place bun, etc.). A particularly useful method to shape foam articles is to start from a foam plank which has been extruded from a thermoplastic comprising a blowing agent. As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded. As defined herein, shaped means the foamed article typically has one or more contour that create a step change (impression) in height 32 of at least 1 millimeter or more in the foam blank 10 having thickness 15 as shown in FIG. 1. A shaped article has at least one surface that is not planar.

The forming of the shaped foam articles is surprisingly enhanced by using foam planks that have at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive balance), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

After the foam plank is formed, a pressing surface is created, for example by removing a layer from the top or bottom surface of the foam plank or by cutting the foam plank between the top and bottom surface to create two pressing surfaces opposite the top and bottom surface. Suitable equipment useful for preparing a pressing surface are band saws, computer numeric controlled (CNC) abrasive wire cutting machines, CNC hot wire cutting equipment and the like. When removing a layer, the same cutting methods just described may be used and other methods such as planing, grinding or sanding may be used.

Typically, after removing a layer from the top and/or bottom surface of the foam plank and/or cutting the plank, the resulting plank with pressing surface is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the foam plank having a pressing surface, has a density gradient from the pressing surface to the opposite surface of the foam plank. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the surface (i.e., within a millimeter or two of the surface) is 3.0 pounds per cubic foot (pcf), the density would be for a 10 percent gradient either 2.7 or 3.3 pcf at the center of the foam.

In one embodiment of the present invention, the shaped foam article 10 may be formed in a foam plank and in a subsequent and separate step, the shaped foam article is separated, or trimmed from the continuous unshaped foam plank 16. In another embodiment, the plank may be cut to fit into a forming tool prior to contact with the tool, the cut foamed plank is sometimes referred to as a foam blank. In another embodiment, the final shape maybe cut from the pressed plank, for example, the foam plank may be pressed to form a shape into the pressing surface and the shaped foam article subsequently cut from the pressed foam plank. When cutting the foam, any suitable method may be used, such as those known in the art and those described previously for cutting the foam to form the pressing surfaces. In yet another, preferred embodiment, the shaped foam article is trimmed from the continuous unshaped foam plank by a trimming rib 51 simultaneously as the shaped foam article is formed. In addition, methods that involve heat may also be used to cut the foam since the pressed shape has already been formed in the pressing surface.

The method of the present invention uses a molding machine, sometimes referred to as a press, to form the shaped foam article of the present invention. Typically, a press has a stationary platen and a movable platen to which a forming tool may be affixed. The pressing surface(s) of the plank is contacted with a forming tool such as a die face or mold. Herein die face and/or mold means any tool having an impressed shape and/or cavity that when pressed into the foam plank will cause the foam to take the shape of the die face. That is, the material making up the forming tool is such that it does not deform when pressed against the foam plank, but the foam plank deforms to form and retain the desired shape of the forming tool, die face, and/or mold cavity. Typically, a mold comprises a cavity portion, or cavity half and a core portion, or core half. The cavity half of the mold may be affixed to the stationary platen, but more often is affixed to the movable platen. Hereinafter, when the mold half with a cavity is affixed to the movable platen is referred to as the movable forming surface and the stationary platen is referred to as the stationary forming surface. The stationary platen may or may not have a mold half with a core affixed to it.

Both sides of the foam plank may be shaped, in this embodiment both the mold half with the cavity and the mold half with the core impart shape to the shaped foam article. In another embodiment, only one surface of the foam plank is shaped. In this embodiment, the foam article is shaped only on one surface pressed by the platen having the half of the mold with the cavity. In this embodiment, the foam plank may be pressed directly against the other platen or against a mold half with a core affixed to the other platen.

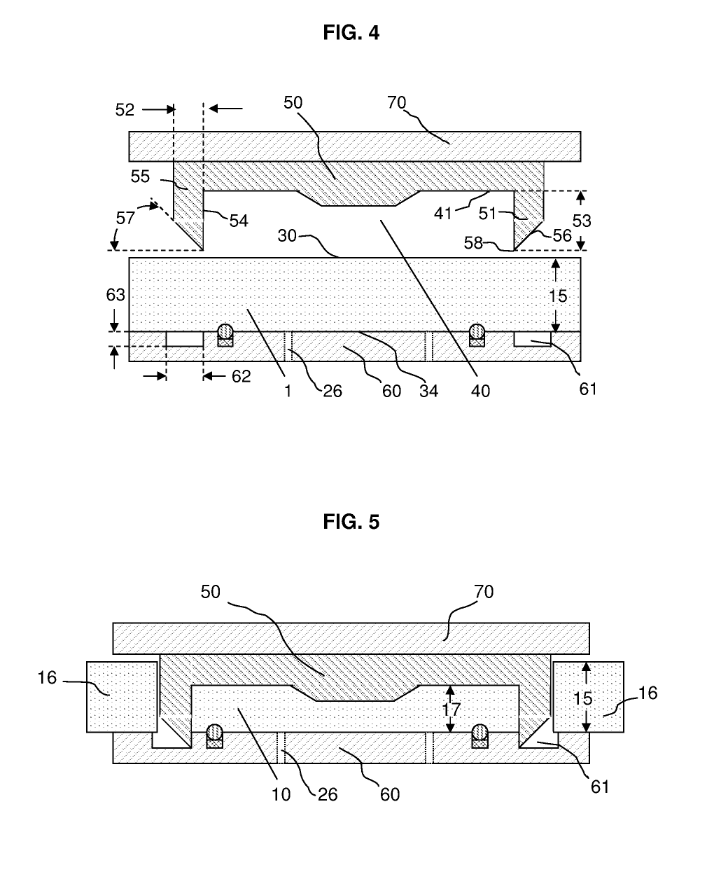

Typically when pressing, at least a portion of the foam is pressed such that the foam is compressed to a thickness of 95 percent or less of the to-be-pressed foam thickness 15 as shown in FIG. 4, which typically corresponds to just exceeding the yield stress of the foam (elastically deforming the foam). Likewise, when pressing the part, the maximum deformation of the foam (elastically deforming the foam) is typically no more than about 20 percent of the original thickness 15 of the foam ready to be pressed. In other words, the final thickness of the pressed foam (shaped foam article) is equal to or less than 80 percent of the original thickness of the foam plank.

The forming tool, because a shape is most often desired, typically has contours that create an impression (step change) in height 32 of at least a millimeter in the shaped foam article 10 having thickness 17 as shown in FIG. 1. The height/depth 32 of an impression may be measured using any suitable technique such as contact measurement techniques (e.g., coordinate measuring machines, dial gauges, contour templates) and non-contact techniques such as optical methods including laser methods. The height of the step change 32 may be greater than 1 millimeter such as 1.5, 2, 2.5, 3, 3.5, 4, 5, 6, 7, 8, 9 and 10 to a height that is to a point where there are no more foam cells to collapse such that pressing further starts to elastically deform the plastic (polymer) of the foam.

The step change, surprisingly, may be formed where the foam undergoes shear. For example, the foam may have a shear angle 33 of about 45° to about 90° from the press surface 35 of the shaped foam article 10 in a step change of height 32. It is understood that the shear angle may not be linear, but may have some curvature, with the angle in these cases being an average over the curvature. The angle surprisingly may be greater than 60°, 75° or even by 90° while still maintaining an excellent finish and appearance.

In another aspect of the invention, a foam having a higher concentration of open cells at a surface of the foam than the concentration of open cells within the foam is contacted and pressed to form the shape. In this aspect of the invention the foam may be any foam, preferably a styrenic foam such as the extruded styrenic polymer foam described above. It may also be any other styrenic polymeric foam such as those known in the art including, for example, where the blowing agent is added to polymer beads, typically under pressure, as described by U.S. Pat. No. 4,485,193 and each of the U.S. patents cited hereinabove.

With respect to this open cell gradient, the gradient is as described above for the density gradient where the concentration of open cells if determined microscopically and is the number of open cells per total cells at the surface.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing/machining or cutting) or may be induced chemically, for example, by use of suitable surfactants to burst closed cells at the surface.

The foam surface with the higher concentration of open cells is contacted with a forming tool and pressed as described above. In a preferred embodiment for such foams, one or both sides of the forming tool, e.g., both sides of the die face and/or mold are heated, but the foam is not (ambient 15-30° C.) and the foam is pressed. Surprisingly, heating the die faces with the foams having open cells at the surface results in superior surface contour and appearance as compared to doing the same with a foam without such open cells at the surface, in this case, the appearance of the foam is degraded.

In another embodiment of the present invention, the shaped foam article may be perforated. Such an article may have a plurality of perforations. Perforation is defined herein to mean one or more hole which passes through the foam plank/shaped article one surface to another, i.e., from the top surface to the bottom surface. Perforation may occur at any time, in other words, it may be done to the foam plank prior to shaping, to the shaped foam article, or a combination of the two. The perforations extend through the shaped foam article, for instance for a shaped foam article made from a foam plank, through the depth of the foam plank. The foam may be perforated by any acceptable means. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

When pressing with a heated forming tool, the contact time with the foam is typically from about 0.1 second to about 60 seconds. Preferably, the dwell time is at least about 1 second to at most about 45 seconds.

When pressing with a heated forming tool, the temperature of the forming tool is not so hot or held for too long a time such that the foam is degraded. Typically, the temperature of the forming tool is about 50° C. to about 200° C. Preferably, the temperature is at least about 60°, more preferably at least about 70° C., even more preferably at least about 80° C. and most preferably at least about 90° C. to preferably at most about 190°, more preferably at most about 180°, even more preferably at most about 170° C. and most preferably at most about 160° C.

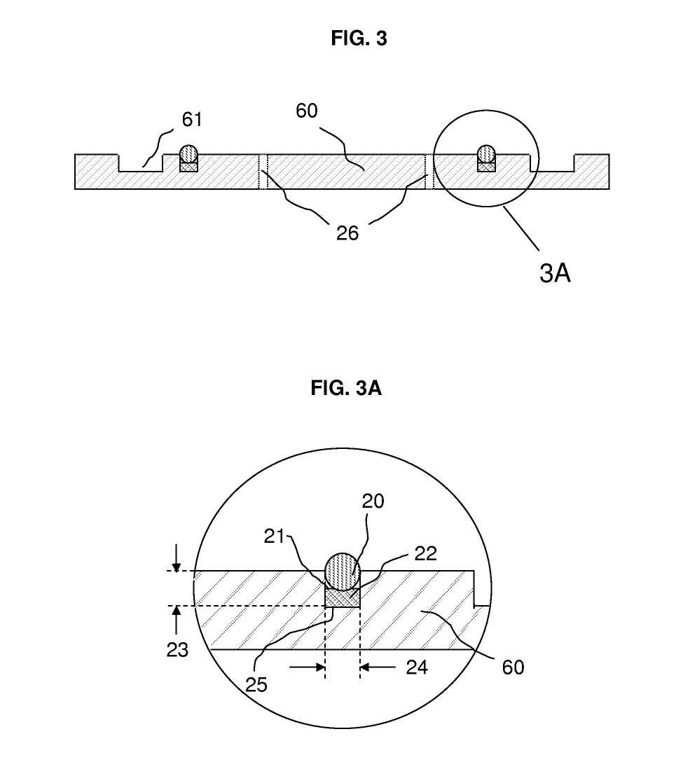

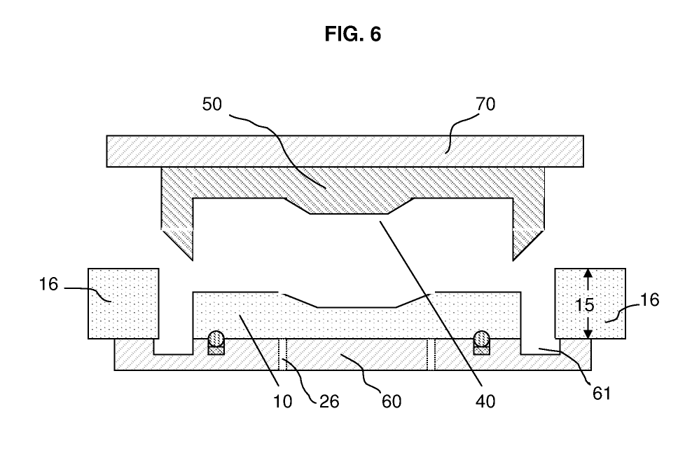

The forming tool provides the shape to the shaped foam article. The forming tool comprises the forming cavity (shape) and all the necessary equipment for temperature control, trimming, ejection, etc. The most frequent case, the forming tool, such as a mold, comprises two halves, one which may be the stationary platen 60 or which is mounted to a stationary platen (sometimes referred to as the core side or stationary forming surface), the other mold half 50 to a moveable platen 70 (sometimes referred to as the cavity side or movable forming surface) and moving with it. The shape of the article will dictate the design and complexity of the forming tool. In the simplest case, the mold half with the cavity is affixed to the movable platen and the stationary forming surface is the stationary platen itself 60 FIG. 2 and FIG. 3. In a preferred embodiment of the present invention, the stationary forming surface is flat, in other words, imparts no shape to the foam plank and the movable forming surface, or cavity, has a defined shape which is imparted into the foam plank pressing surface 30 when impressed upon the foam plank 1, FIG. 4 to FIG. 6. In another embodiment of the present invention (not illustrated in the accompanying drawings), both the stationary and movable forming surfaces of the forming tool impart shape to the foam plank.

In one embodiment of the present invention the shaping/trimming step of the present invention, the surface of the foam plank 34 opposite the pressing surface(s) 30 of the foam plank is placed on a stationary forming surface, such as a stationary platen 60. A movable platen 70 which can move toward or away from the stationary platen on which the plank is placed comprises a movable forming surface of the forming tool 50 for example, a single cavity mold or optionally a multiple cavity mold. To shape the foam, the movable platen moves towards the stationary platen such that the pressing surface(s) of the plank 30 is contacted and pressed with the movable forming surface of the forming tool 50. For a multi-cavity mold, each cavity may be identical in shape or there may be as many different shapes as cavities or there may be a combination of multiple cavities with the same first shape in combination with multiple cavities with one or more shapes different than the first shape. The layout of cavities in a multi-cavity mold may be side by side, in tandem, or any other desirable configuration. A multi-cavity mold produces more than one shaped article in a plank per molding cycle.

In conventional forming processes, frictional forces result in the shaped foam article remaining in the cavity half of the mold as the mold opens. The shaped foam article is then ejected from the cavity half of the mold by conventional means, such as knock out pins, a core pull, removable inserts, cams, unscrewing, stripper plate, stripper ring, manual removal, and the like.

The method of the present invention differs from the prior art in that when the mold opens, the shaped formed article 10 is retained on the platen without the cavity half of the mold or the core half of the mold when affixed to a platen (e.g., stationary forming surface 60 when the cavity half of the mold is affixed to the movable platen) by means of negative pressure or vacuum, thus extracting it from the mold cavity as the mold opens. In one embodiment of the present invention, the foam plank rests on the platen without the cavity half of the mold, i.e., the stationary forming surface which is the stationary platen 60 in FIGS. 4 to 6. There is one or a plurality of holes 26 through the stationary platen 60 from which negative pressure, e.g., vacuum, can be applied to the surface of the foam plank 34. The number, location and/or the diameter of the holes needed to retain the shaped foam article 10 on the stationary platen 60 may easily be determined by trial and error.

The vacuum is applied prior to opening the mold such that when the mold opens, the shaped foam article is retained on the platen without the cavity half of the mold or the core half of the mold when affixed to a platen (e.g., stationary forming surface 60 when the cavity half of the mold is affixed to the movable platen). Any acceptable mean to draw a vacuum may be employed; said means is not illustrated in the drawings. A suitable negative pressure is one that retains the shaped foam article on the stationary forming surface when the mold opens. Preferably a negative pressure of at least 10 pounds per square inch (psi) is applied to the foam plank 1/shaped foam article 10, more preferably at least 11 psi, even more preferably at least 12 psi, even more preferably at least 13 psi, and most preferably at least 14 psi is applied to the foam plank 1/shaped foam article 10.

In another embodiment of the present invention, the stationary molding surface is a core half of the mold attached to the stationary platen on which the foam plank rests and there are one or more holes through the mold half (not illustrated in the drawings) that align with the holes 26 in the stationary platen 60 through which when a vacuum is drawn, the shaped foam article is retained onto the core half of the mold mounted to the stationary platen when the mold opens.

In another embodiment of the present invention, the platen without the cavity half of the mold affixed to it and/or the core half of the mold is made of porous media, for example a porous metal or a composite material consisting of two major components such as aluminium or ceramic materials, and binders. Preferably, the porous media has a micro-porous structure which is air-permeable over its entire surface. In contrast to sintered materials, the pores are not closed off after machining. Vacuum may be pulled through the large number of small holes (pores) resulting in minimal defects on the surface of the foam plank 34. Suitable examples of porous material are METAPOR™ and PORCERAX™ Air Permeable Products available from CMT Materials, Inc. METAPOR Air Permeable Products have a porosity of about 20 percent.

In an embodiment of the present invention, the forming surface on which the foam plank rests (e.g., the platen itself or a core half of the mold affixed to a platen (not pictured)) comprises a seal means to improve the seal between the foam plank and the stationary forming surface (or core half of the mold). In one embodiment, the seal means comprises a groove in the stationary forming surface fitted with an elastomeric seal. The groove has a depth which is defined as the distance from the stationary forming surface to the bottom surface of the groove.

In a preferred embodiment of the present invention, when the cavity half of the mold is affixed to the movable platen (e.g., the movable forming surface) the stationary forming surface on which the foam plank rests (e.g., the stationary platen itself 60 or a core half of the mold (not pictured)) comprises a seal means FIG. 3A to improve the seal between the foam plank and the stationary forming surface 60 (or mold half). In one embodiment, the seal means comprises a groove 21 in the stationary forming surface fitted with an elastomeric seal 20. The groove 21 has a depth 23 which is defined as the distance from the stationary forming surface to the bottom surface of the groove 25.

Optionally, there is a seal shim 22 in the groove 21 between the bottom of the groove 25 and the seal 20. The seal shim may 22 be employed to improve the sealing efficiency of the seal 20 by positioning the seal 20 at the optimal height above the surface of the stationary forming surface to provide a seal with the foam plank/shaped foam article 10. The seal shim may be made from any suitable material which positions the seal at the desired height, for example it can be made of plastic, steel, wood, aluminum, copper, brass, and the like.

The seal may be made of any material which will reproducibly (i.e., elastically) create and maintain a vacuum between the foam plank/shaped foam article 10 under negative pressure. For example, suitable materials are neoprene, silicone, buna-N, EPDM foam, polyurethane foam, and the like.

Preferably the seal has a Shore A hardness of between 10 to 70.

The seal preferably compresses at least 15 percent, more preferably 25 percent, and more preferably 35 percent or greater based on the thickness of the seal under compression relative to the thickness of the uncompressed seal.

The vacuum surface area is defined herein as a percentage and is determined as the area of the foam plank 1/shaped foam article 10 within the perimeter of the seal 20 versus the area defined by the perimeter of cavity 40 in the movable forming surface. Preferably, the vacuum surface area is equal to or greater than 20 percent, preferably equal to or greater than 40 percent, and more preferably equal to or greater than 60 percent.

The perimeter or outline of the groove 21 may be any shape, e.g., round, square, triangular, rectangular, etc., and may be defined by the shape of the shaped foam article 10 and/or the amount of vacuum surface area required to retain the shaped foam article on the stationary forming surface when the mold opens. Preferably, the shape of the groove is symmetrical as shown in FIG. 2.

The seal 20 may have any cross section, but is preferably round. For a round seal, its diameter is not critical as long as the seal provides a sufficient seal surface between the stationary forming surface and the foam plank 1/shaped foam article 10.

The groove has a width 24 and a depth 23. Preferably the width of the groove 24 is 6.66 percent larger than the diameter of the seal. Preferably the depth of the groove 23 is at least 15 percent smaller than the diameter of the seal.

### Test Methods

The density profile through the thickness of each foam blank was tested using a QMS Density Profiler, model QDP-01X, from Quintek Measurement Systems, Inc. Knoxyille, Tenn. The High Voltage kV Control was set to 90 percent, the High Voltage Current Control was set to 23 percent and the Detector Voltage was approximately 8v. Data points were collected every 0.06 mm throughout the thickness of the foam. Approximate thickness of the foam samples in the plane of the x-ray path was 2 inches. Mass absorption coefficients were calculated for each sample individually, based on the measured linear density of the foam part being tested. The skin density, ρₛₖᵢₙ, was reported as a maximum value whereas the core density, P_{core}, was averaged within an approximate 5 mm range. The density gradient, in units of percentage, was then computed in accordance with the following equation:

$$Density Gradient ( percent ) = 100 \cdot \frac{( {ρ}_{core} - {ρ}_{skin} )}{{ρ}_{skin}}$$

The compressive response of each material was measured using a Materials Test System equipped with a 5.0 displacement card and a 4,000 lbf load card. Cubical samples measuring the approximate thickness of each plank were compressed at a compressive strain rate of 0.065 s⁻¹. Thus, the crosshead velocity of the MTS, in units of inches per minute, was programmed in accordance with the following equation:

Crosshead Velocity=Strain Rate*Thickness*60

where the thickness of the foam specimen is measured in units of inches. The compressive strength of each foam specimen is calculated in accordance with ASTM D1621 while the total compressive strength, C_{ST}, is computed as follows:

C_{ST}=C_{SV}+C_{SE}+C_{SH}

where C_{SV}, C_{SE} and C_{SH} correspond to the compressive strength in the vertical, extrusion and horizontal direction respectively. Thus, the compressive balance, R, in each direction can be computed as shown below:

R_{V}=C_{SV}/C_{ST}

R_{E}=C_{SE}/C_{ST}

R_{H}=C_{SH}/C_{ST}

Open cell content was measured by using an Archimedes method on 25 mm×25 mm×50 mm samples.

While certain embodiments of the present invention are described in the following example, it will be apparent that considerable variations and modifications of these specific embodiments can be made without departing from the scope of the present invention as defined by a proper interpretation of the following claims.

### Example

For Comparative Example A and Example 1 an IMPAXX™ 300 Foam Plank, available from The Dow Chemical Co., Midland, Mich. is used. The IMPAXX 300 Foam Plank is an extruded polystyrene foam with dimensions measuring 2,200 mm by 600 mm by 110 mm in the length, width and thickness directions respectively. The IMPAXX 300 Foam Plank has a density gradient of about −18.6 percent, an open cell content of about 4.9, and a cell gas pressure of about 0.6 atmosphere (atm). About 7 millimeters (mm) layer is removed by planing from the top and the bottom of an IMPAXX 300 Foam Plank. The planed IMPAXX 300 Foam Plank is then cut to render a foam blank having a planed surface (top or bottom) opposite a cut surface (core) measuring approximately 355 mm by 241 mm by 50 mm, in the length, width and thickness directions respectively. The cut, or core, surface of the foam blank is then compressed against the movable forming surface comprising a mold cavity in the shape of cedar shake shingles at ambient temperature until the movable upper platen contacts a series of 19 mm stop blocks. Once the stop blocks are contacted, the platens are opened and the shaped foam article is removed from the surface of the casting tool with no dwell or residence time in the mold. During the pressing, the foam is subjected to a maximum applied compressive strain of about 60 to about 65 percent.

The stationary forming surface is the stationary platen. There are two 12.7 mm diameter holes drilled through the stationary platen through which a vacuum can be drawn. There is a circular groove in the stationary platen having a 187 mm diameter with a depth of 8.13 mm in which a circular seal can be placed. For Comparative Example A, there is no seal placed in the groove and no vacuum is pulled through the holes in the stationary platen. For Example 1, a neoprene rubber seal having a 30 durometer Shore A hardness with a diameter of 9.53 mm is placed in the groove and a vacuum of 14 psi is pulled on the cut side of the foam blank from mold closure to mold opening.

The shaped foam article produced in Comparative Example A stays in the mold cavity when the mold is opened and must be removed from the cavity manually. The shaped foam article produced in Example 1 is retained on the stationary platen when the mold is opened and does not need be manually removed from the cavity.

1. A method to manufacture one or more shaped foam article using a press with a movable platen and a stationary platen, said press comprises a mold with a cavity half affixed to either the movable platen or the stationary platen wherein the platen that does not have the cavity half of the mold affixed to it has means to apply a negative pressure through it comprising the steps of:
(i) extruding a thermoplastic polymer with a blowing agent to form a thermoplastic polymer foam plank, the plank having a thickness, a top surface, and a bottom surface in which said surfaces lie in the plane defined by the direction of extrusion and the width of the plank, wherein the foam plank has
(i)(a) a vertical compressive balance equal to or greater than 0.4
and
(i)(b) one or more pressing surface;
(ii) applying a negative pressure though the platen without the cavity half of the mold to the surface opposite the surface of the foam plank to be pressed,
(iii) shaping the one or more pressing surface of the foam plank into one or more shaped foam article and surrounding unshaped foam plank by
(iii)(a) moving the movable platen in contact with the foam plank,
(iii)(b) pressing the foam plank into the cavity half of the mold, said cavity half of the mold comprises one or a plurality of cavities each cavity having a perimeter defining the shape of the shaped foam article,
(iii)(c) forming one or more shaped foam article, and
(iii)(d) retracting the movable platen from the stationary platen,
whereby the one or more shaped foam article is retained by negative pressure on the platen without the cavity half of the mold.

2. A The method of claim 1 wherein the movable platen has affixed to it the mold half with a cavity and the stationary platen has means to apply a negative pressure through it.

3. The method of claim 2 wherein the means to apply negative pressure through the stationary forming surface comprise one or more hole through the stationary forming surface through which a vacuum may be applied.

4. The method of claim 2 wherein the stationary forming surface comprises a porous media through which the negative pressure is applied.

5. The method of claim 3 wherein the means to apply negative pressure through the stationary forming surface further comprises a seal means between the foam plank and the stationary forming surface.

6. The method of claim 5 wherein the seal means comprises a groove in the stationary forming surface and a seal that fits within the groove wherein the perimeter of the groove is smaller than the shape of the shaped foam article as defined by the perimeter of the mold cavity.

7. The method of claim 1 or 2 wherein the pressing surface is created by the step of
(i)(b)(1) removing a layer of foam at least 1 millimeter thick from the top surface, the bottom surface, or both the top and bottom surfaces
or
(i)(b)(2) cutting the foam plank between the top and the bottom surfaces creating two pressing surfaces opposite the top and bottom surfaces.

8. The method of claim 2 wherein the foam has a cell gas pressure equal to or less than 1 atmosphere.

9. The method of claim 2 wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

10. The method of claim 2 wherein the blowing agent is a chemical blowing agent, an inorganic gas, an organic blowing agent, carbon dioxide, or combinations thereof.
